(19) United States
(12) Patent Application Publication
(10) Pub. No.: US 2026/0213524 A1
(43) Pub. Date: Jul. 23, 2026

(54) HARDWARE-BASED SHORT CIRCUIT PROTECTION FOR TRAFFIC CONTROL SYSTEMS

(71) Applicant: Polara Enterprises, L.L.C., Greenville, TX (US)

(72) Inventors: Ethan Coxsey, Phoenix, AZ (US); Todd Hagan, Plano, TX (US)

(21) Appl. No.: 19/458,541

(22) Filed: Jan. 23, 2026

Related U.S. Application Data
(60) Provisional application No. 63/748,907, filed on Jan. 23, 2025.

(51) Int. Cl. H02H 7/22; G08G 1/07

(52) U.S. Cl. CPC H02H 7/22; G08G 1/07

(57) ABSTRACT

Methods and systems for system and method hardware-based short circuit protection for traffic control systems. A traffic control cabinet system includes a controller, and a traffic control power circuit coupled to the controller. The traffic control power circuit includes a current sensing circuit coupled to a signal head, a driving circuit configured to supply current flow to the signal head, and an overcurrent detection circuit. The overcurrent detection circuit includes a conditioning circuit coupled to the current sensing circuit and configured to receive a sensed current from the current sensing circuit, a comparator coupled to the conditioning circuit, a microcontroller coupled to the comparator, and a switch coupled to the driving circuit.

### CROSS-REFERENCE TO RELATED AND CLAIM OF PRIORITY

The present application claims priority under 35 U.S.C. § 119(e) to U.S. Provisional Patent Application No. 63/748,907 filed on January 23, 2025, which is hereby incorporated by reference in its entirety.

### TECHNICAL FIELD

The present disclosure relates generally to traffic control systems. More specifically, the present disclosure relates to a system and method hardware-based short circuit protection for traffic control systems.

### BACKGROUND

Traffic control systems are designed to ensure the safety of vehicular and pedestrian traffic. These systems, however, are susceptible to short circuits that may damage loads coupled to the power supplies or damage components within the power supplies. Firmware may be used to shut down the output once the load reaches a critical value. However, software or firmware based over current protection schemes do not react fast enough to protect the output devices of a traffic control system in the event of a short circuit of the output.

Accordingly, there is a need for systems and methods for hardware-based short circuit protection of circuit elements in a traffic control system.

### SUMMARY

The present disclosure relates generally to traffic control systems and, more specifically, the present disclosure relates to a system and method for hardware-based short circuit protection for traffic control systems.

In one embodiment, a traffic control cabinet system is provided. The traffic control cabinet system includes a controller, and a traffic control power circuit coupled to the controller. The traffic control power circuit includes a current sensing circuit coupled to a signal head, a driving circuit configured to supply current flow to the signal head, and an overcurrent detection circuit. The overcurrent detection circuit includes a digital-to-analog converter coupled to the current sensing circuit and configured to receive a sensed current from the current sensing circuit, a comparator coupled to the digital-to-analog converter, a microcontroller coupled to the comparator, and a switch coupled to the driving circuit.

In another embodiment, a traffic control power circuit is provided. The traffic control power circuit includes a current sensing circuit coupled to a signal head, a driving circuit configured to supply current flow to the signal head, and an overcurrent detection circuit. The overcurrent detection circuit includes a digital-to-analog converter coupled to the current sensing circuit and configured to receive a sensed current from the current sensing circuit, a comparator coupled to the digital-to-analog converter, a microcontroller coupled to the comparator, and a switch coupled to the driving circuit.

In yet another embodiment, a traffic control power circuit is provided. The traffic control power circuit includes a current sensing circuit coupled to a signal head. The traffic control power circuit also includes a driving circuit configured to supply current flow to the signal head. The traffic control power circuit also includes an overcurrent detection circuit. The overcurrent detection circuit includes a conditioning circuit coupled to the current sensing circuit and configured to receive a sensed current from the current sensing circuit. The overcurrent detection circuit also includes a comparator coupled to the conditioning circuit by a first input. The overcurrent detection circuit also includes a microcontroller coupled to the comparator. The overcurrent detection circuit also includes a switch coupled to the driving circuit. The overcurrent detection circuit also includes a first resistor and a second resistor coupled to a second input of the comparator.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a schematic top view of an example traffic control environment according to various embodiments of the present disclosure;

FIG. 2 illustrates a block diagram of an example traffic control cabinet system according to various embodiments of the present disclosure;

FIG. 3 illustrates a block diagram of an example traffic control power circuit traffic control power circuit for a traffic control cabinet system according to various embodiments of the present disclosure;

FIGS. 4A and 4B illustrate block diagrams of example overcurrent detection circuits that may be used in a traffic control circuit according to various embodiments of the present disclosure; and

FIG. 5 illustrates a flow chart of an example method for hardware-based short circuit protection of traffic control systems according to various embodiments of the present disclosure.

### DETAILED DESCRIPTION

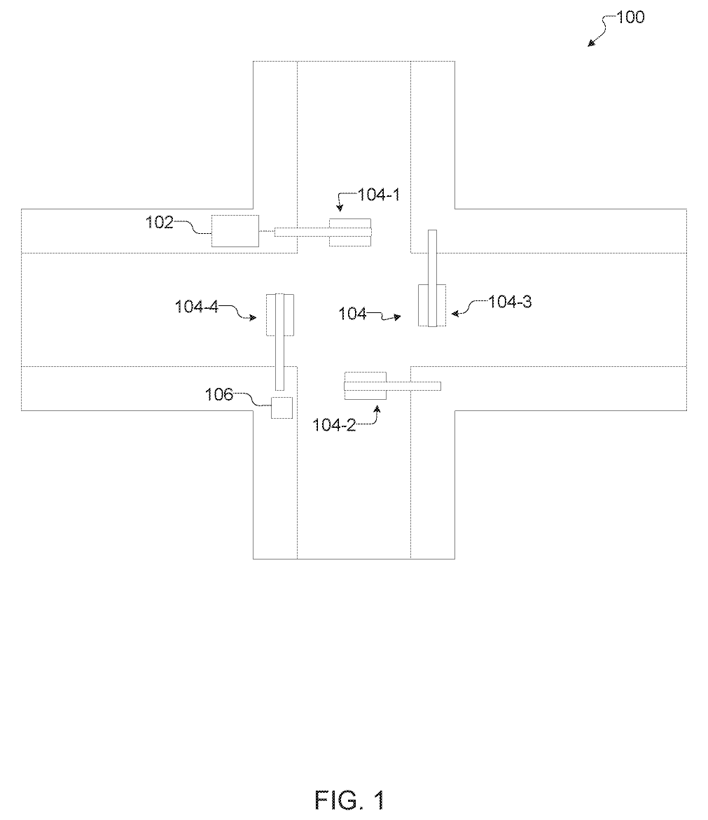

FIG. 1 through FIG. 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

As introduced above, traffic control systems are designed to ensure the safety of vehicular and pedestrian traffic. These systems have included, for example, traffic signal control structures, malfunction management units, vehicle pre-emption and prioritization devices, data aggregators, vehicle detection systems, time sync signal generators, and power supplies operatively coupled together, and enclosed and protected by a control cabinet. These components can communicate with traffic signals, other traffic control systems, or with a central command center through hard-wired interconnects, through one or more cloud-based or locally deployed servers, or combinations thereof to control traffic.

As these sub-systems include circuits, however, they are susceptible to short circuits. For example, a short circuit condition may cause the power supply within a traffic monitor system to generate dangerously high currents. The current levels may damage loads coupled to the power supplies or damage components within the power supplies.

Embodiments of the present disclosure recognize that, to address short circuits, firmware is used to shut down the output once the load reaches a critical value. However, the time to detect this and react is in the order of hundreds of microseconds. This reaction time is too long to protect the MOSFETS used in the traffic control system in the event of a short circuit. Fusing has been installed in some traffic cabinets to provide protection, but this requires intervention to replace and additional hardware within the cabinet that has restricted space. In particular, fusing adds additional hardware, maintenance, testing, and potential failure points to the cabinet. If installed incorrectly, protection may not be adequate to protect the traffic control system.

Accordingly, the present disclosure provides a traffic control system that includes using the existing circuits that measure the current flow within the system along with an overcurrent detection circuit that will react when the current flow in the traffic control system exceeds a predetermined threshold. The predetermined threshold may be controlled through the use of a digital-to-analog converter to provide a variable protection level. The overcurrent detection circuit is configured to shut down a channel experiencing a short circuit and will latch the drive output off to prevent inadvertent retriggering. The circuit may also transmit a signal to the controlling circuit to alert it to the fault. The overcurrent detection circuit may remain latched until the controlling circuit sends a signal to clear the fault.

FIG. 1 illustrates a schematic top view of an example traffic control environment 100 according to various embodiments of the present disclosure.

As shown in FIG. 1, a traffic control environment 100, e.g., a four-way intersection, is controlled by a cabinet 102. In the example shown in FIG. 1, cabinet 102 controls a plurality of signal heads 104, e.g., a first signal head 104-1, a second signal head 104-2, a third signal 104-3, a fourth signal head 104-4, and a pedestrian signal head 106. By way of example, the first signal head 104-1 and the second signal head 104-2 may control traffic flow in a north-south direction and the third signal head 104-3 and the fourth signal head 104-4 may control traffic flow in an east-west direction. It should be noted that a signal head may be an assembly including one or more signal faces that are configured to control traffic movement on one or more approaches, a signal housing to protects the light source from mechanical or environmental stresses, a signal lens, and a light source. It should be further noted that the signal lens may be an optional component that redirects the light coming directly from the light source.

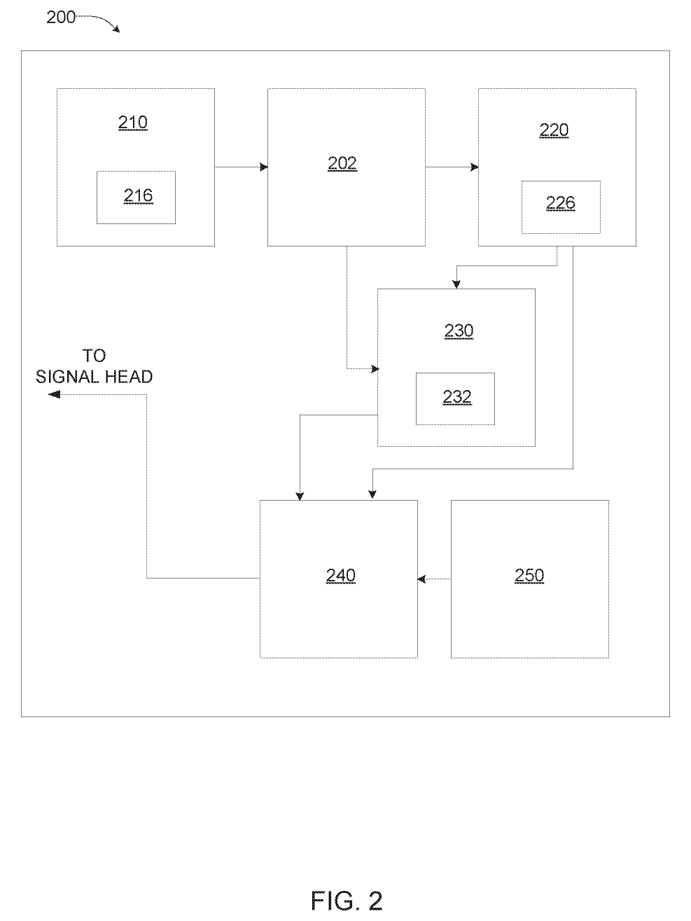

The cabinet 102 houses a traffic control system, e.g., traffic control cabinet system 200 of FIG. 2, that controls the plurality of signal heads 104 and the pedestrian signal head. For clarity, FIG. 1 only shows the connection between the traffic control system housed by cabinet 102 and signal head 104-1 of the plurality of signal heads 104. It should be noted that the traffic control system housed in cabinet 102 may communicate with the plurality of signal heads 104 and the pedestrian signal head 106 using, for example, metal cables, fiber optic cables, wireless communication, or the like. It should be noted that the plurality of signal heads 104 connected to cabinet 102 is not limited to four and that the pedestrian signal head 106 is not limited to only one. There may be, for example, one, two, three, four, or more signal heads connected to cabinet 102.

FIG. 2 illustrates a block diagram of an example traffic control cabinet system 200 according to various embodiments of the present disclosure. For example, the traffic control cabinet system 200 may be used to control signal heads of the traffic control environment 100 of FIG. 1.

As shown in FIG. 2, traffic control cabinet system 200 may include a controller 202, an input assembly 210, an output assembly 220, a Malfunction Management Unit (“MMU”) 230, a flash transfer relay 240, and a flasher 250. One or more signal heads 104 may be connected to the traffic control cabinet system 200. For example, the traffic control environment 100 shown in FIG. 1 includes four signal heads are connected to the traffic control cabinet system 200. The traffic control cabinet system 200 may be mounted in a cabinet 102, where the cabinet 102 provides protection from physical stresses such as automobiles striking one or more elements of the traffic control cabinet system 200, or animals nesting in or on elements of the traffic control cabinet system 200. In addition, the cabinet 102 may provide protection from environmental stresses such as rain, snow, ice, wind, heat, exposure to sunlight, or the like. The cabinet 102 may be referred to, for example, as a cabinet, an enclosure, a protective structure.

The input assembly 210 is configured to receive an input signal VIN and an array 216 of input devices. The array 216 of input devices may include one or more vehicle detectors 216-1, 216-2, . . . , 216-n, where n is an integer. By way of example, the array 216 is included of an array of vehicle detectors configured to receive input signals VIN from an intersection environment through embedded inductive loops or other such sensors.

The controller 202 is coupled to the input assembly 210 and to the output assembly 220. In addition, controller 202 is operably coupled to the MMU 230, for example, through a bi-directional communications connection such as a single wire communications bus. The output assembly 220 includes an array of load switches 226 including one or more load switches 226-1, 226-2, . . . , 226-m, where m is an integer. The output assembly 220 is coupled to the MMU 230, e.g., using a bi-directional communications connection such is a single wire bidirectional communications bus.

The output assembly 220 is connected to the flash transfer relay 240, for example, through a single channel unidirectional communications connection, which may be a single wire communications bus. The output assembly 220 is operably coupled to the plurality of signal heads 104 and the pedestrian signal head 106. The array of load switches 226 may communicate with the environment via an output terminal to effect traffic control via activation of the appropriate traffic signal. For example, the controller 202 may communicate with and controls the various assemblies within cabinet 102.

The MMU 230 is configured to detect and respond to conflicting or otherwise improper signals caused by a malfunctioning controller, faulty load switches such as, for example, load switches 226-1, 226-2, . . . , 226-m, cabinet mis-wiring, improper supply voltages, or other such faulty mechanisms. The MMU 230 may be configured as a 6-channel monitor, a 12-channel monitor, a 16-channel monitor, a 32-channel monitor, etc. Inputs of the MMU 230 form a channel. The number of channels for the MMU 230 may be any desired number of channels. Similarly, the number of signal heads connected to the MMU 230 may be any desired number of signal heads. A traffic intersection may have one, two, three, four, or more signal heads connected to the MMU 230. It should be noted that an MMU may be referred to as a signal monitor, a conflict management unit, or the like.

The MMU 230 includes a flash signal detection module 232 which may include any suitable combination of hardware, software, and/or non-transitory computer-readable media configured to detect the occurrence of at least two light sources from sections of a signal head, e.g., a red light section, a yellow light section, and a green light section, being active or on at the same time or no signal sections being active. Two or more light sources from signal sections being active at the same time, e.g., simultaneously, may occur, for example, because of physical shorting in communications busses to the signal sections of the signal head. The short circuit can occur either inside or outside of cabinet 102.

When one or more failures occurs, the MMU 230 instructs or, more generally, causes other components to instruct the signal sections to enter the flash mode, in which the signal head or signal heads at all sides of the intersection generally enters a flashing red state. More particularly, flash transfer relay 240 is instructed directly by MMU 230 to configure a traffic control device, such as, for example, signal head 104 to enter the flash mode.

The controller 202 can include one or more processors or other processing devices that control the overall operation of the traffic control cabinet system 200. For example, the controller 202 could control the timing of flashes in each light of the signal head. The controller 202 could support additional functions as well, such as more advanced traffic control functions. In some embodiments, the controller 202 includes at least one microprocessor or microcontroller. The controller 202 is also capable of executing programs and other processes resident in at least one memory. The controller 202 can move data into or out of the at least one memory as required by an executing process.

Although FIG. 2 illustrates one example of a traffic control cabinet system, various changes may be made to FIG. 2. For example, a different backhaul structures may be present to perform one or more of the above functions.

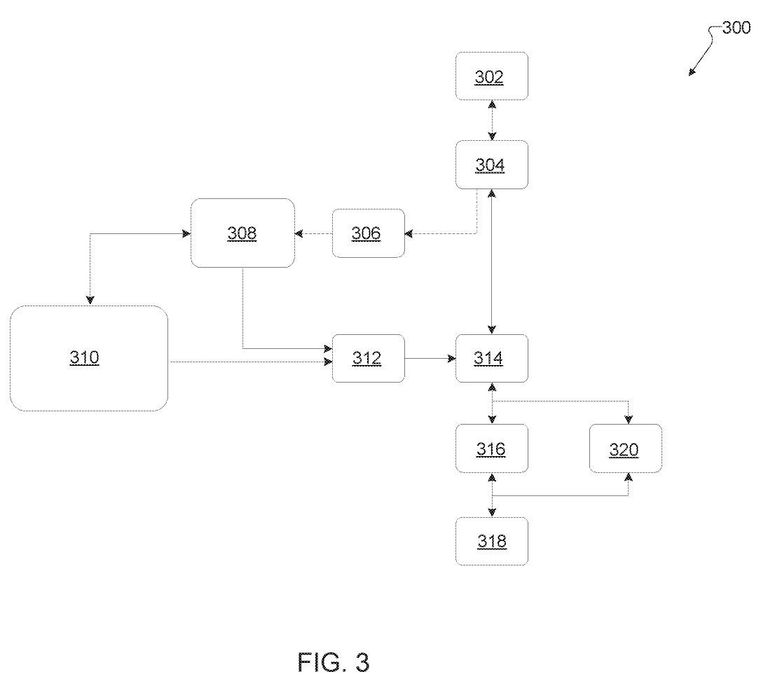

As discussed above, the controller/processor may control the overall operation of the traffic control cabinet system 200, which also includes controlling the current flow to the signal head. In particular, the controller may include a traffic control power circuit configured to drive current to the signal head, such as the example traffic control power circuit discussed in FIG. 3.

FIG. 3 illustrates a block diagram of an example traffic control power circuit 300 for a traffic control cabinet system according to various embodiments of the present disclosure. For example, the traffic control power circuit 300 may be used to control current flow through the traffic control cabinet system 200 of FIG. 2.

As shown in FIG. 3, the traffic control power circuit 300 includes a power source 302 that provides power to a current sense circuit 304, an output device 314, a load 316, and ultimately to a power return 318. The power source 302 may be, for example, an AC power source, such as from a utility power grid, but may also be a battery power source, e.g., using an uninterruptable power supply, power from solar cells, or a DC power source. The current sense circuit 304 may be a circuit configured to monitor an electrical current flow through the power source 302 and acts as an initial safety mechanism to detect potential issues such as overloaded circuits or failing components. In particular, the current sense circuit 304 may measure the current draw by the traffic control power circuit 300.

The traffic control power circuit 300 also includes a microprocessor 310 operably coupled to the current sense circuit 304 by a current scaling circuit 306 and an overcurrent detection circuit 308. The current scaling circuit 306 may be configured to control and adjust the electric current flowing through to the microprocessor 310, allowing for the current to be “scaled” up or down as needed. The overcurrent detection circuit 308 is a hardware-based overcurrent detection circuit and configured to safeguard the traffic control power circuit 300 from excessive current flow and preventing damage to other components of the traffic control power circuit 300.

The current sense circuit 304 is operably coupled to a driving circuit 312 that drives the output device 314. The driving circuit 312 is configured to power the output device 314 by allowing current flow to the output device 314. The driving circuit 312 may include relays or transistors and other necessary circuitry to provide power to different aspects of the output device 314, e.g., different lights at the signal head.

In the event that a short circuit 320 occurs at the load 316, the surge in current flow is detected by the current sense circuit 304 and processed by the overcurrent detection circuit 308. The overcurrent detection circuit 308 then disables the driving circuit 312, preventing current flow to the output device 314.

Although FIG. 3 illustrates one example of a traffic control power circuit, various changes may be made to FIG. 3. For example, the current sense circuit and the current scaling circuit may be incorporated into the overcurrent detection circuit.

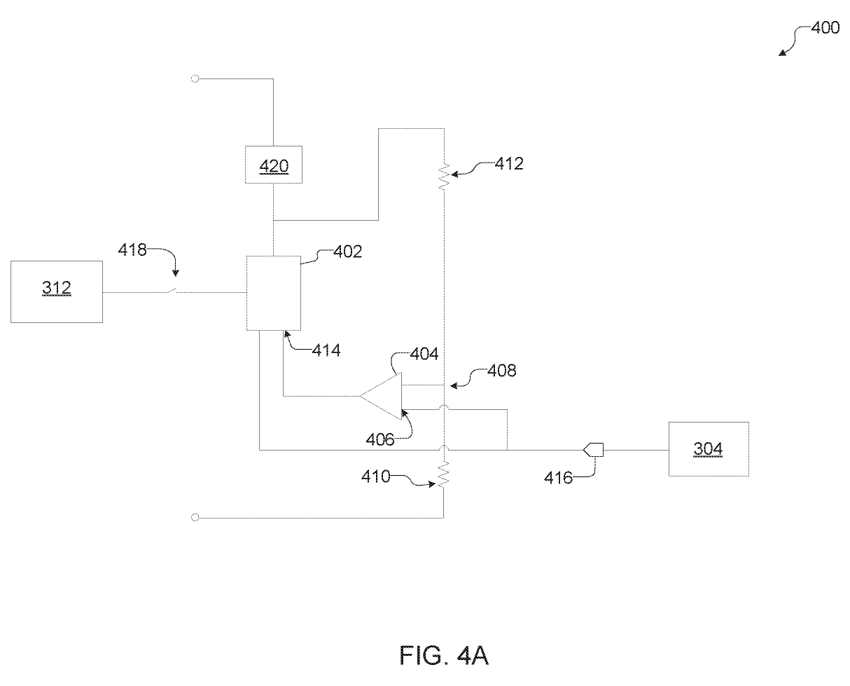

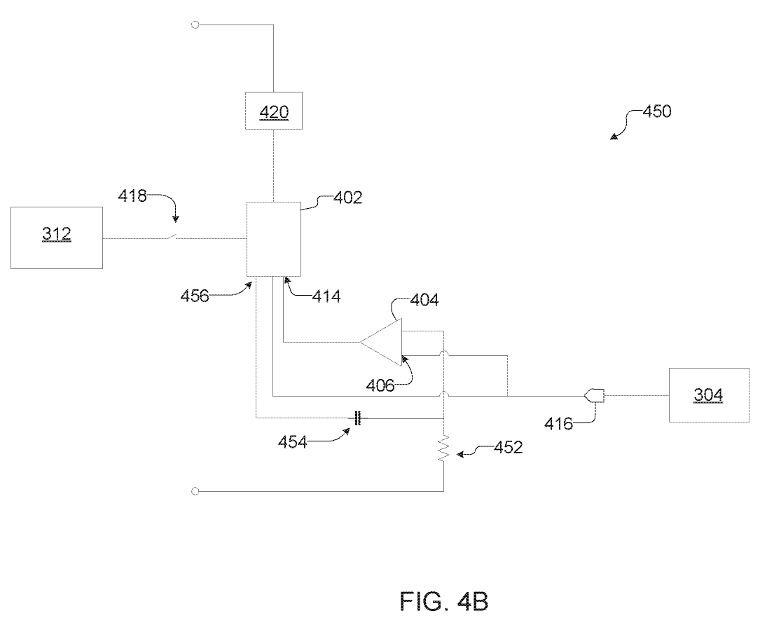

To avoid the use of software or firmware to determine if there is a surge condition that requires overcurrent protection, the overcurrent detection circuit of the present disclosure is hardware-based. Examples of the hardware-based overcurrent detection circuit are described in FIGS. 4A and 4B.

FIGS. 4A and 4B illustrate block diagrams of example overcurrent detection circuits 400, 450 that may be used in the traffic control power circuit 300 of FIG. 3 according to various embodiments of the present disclosure.

As shown in FIG. 4A, the overcurrent detection circuit 400 upon sensing a current, e.g., using the current sense circuit 304 passing through the load 316, sends the voltage to a conditioning circuit 416 to convert the signal into scaled voltage signal before sending the signal to an op-amp or other form of comparator 404. The conditioning circuit 416 conditions the circuit such that a current is scaled appropriately for the comparator when the critical current is reached and will allow the same comparator to observe both positive and negative current pulses.

The sensed current is fed to a first input 406 of the comparator 404 and the second input 408 of the comparator 404 is fed by the junction of a first resistor 410 and a second resistor 412 forming a voltage divider circuit. The first resistor 410 and the second resistor 412 are connected in series between the output of the linear DC-DC converter (voltage regulator) 420 and the bottom rail. The voltage divider sets a reference voltage representative of a predetermined threshold current which the sensed current across current sense circuit 304 cannot rise above in an overcurrent situation. Importantly, the output of the comparator 404 is fed to an Interrupt input 414 on the microcontroller 402. The comparator 404 and voltage divider include thresholding circuitry operable to determine if a signal indicative of a signal head current (i.e. the sensed current) exceeds a reference level.

When the threshold current determined, e.g., a fault condition occurs, by the reference voltage set by the voltage divider is exceeded, the interrupt input 414 is triggered, the driving circuit 312 is disabled, and the microcontroller 402 also switches off power to the driving circuit 312, effectively disabling the drive output to the signal head, using a switch 418. The switch 418 will be latched by the comparator 404, meaning that the switch 418 will not reset or allow current flow to the driving circuit 312 until the fault condition is cleared either manually or by the microcontroller 402. This arrangement offers real time current limiting or protection whereas the reaction time of conventional techniques was limited by the response time of the internal threshold detector and the processing speed of the microcontroller 402. This configuration also allows for protection of the circuit even if the microcontroller 402 has been damaged. It will be appreciated that this arrangement takes the thresholding function out of the microcontroller 402, thereby obviating the need for the internal threshold detector.

Further, the microcontroller 402 may transmit an alert to the controller 202 indicating that the predetermined threshold of current flow has been exceeded, e.g., a fault condition has occurred, so that the controller 202 may perform necessary actions, e.g., transmit a maintenance request, to clear the fault condition. Once the fault condition is cleared, the latch condition may be cleared, e.g., the switch 418 may allow current flow through to the driving circuit 312 and enable drive output to the signal head.

Optionally, the conditioning circuit 416 may be configured to apply a time delay to the sensed current. This additional configuration may be useful in situations where a current surge is anticipated and factored into the design of a traffic control system. For example, when a signal head is powering up, e.g., initially or from a reboot, the startup current for the signal head is significantly larger than the normal current flow of a steady-state operation of the signal head. By applying time delay circuitry, the conditioning circuit 416 dampen the voltage to the comparator 404 and avoid unintentionally triggering a fault condition. Alternatively, the conditioning circuit 416 may include a temporal aspect where, rather than not transmitting a signal to the comparator 404, the conditioning circuit 416 will scale down the voltage for a predetermined period of time, e.g., during an anticipated startup period of a signal head. This configuration would allow for overcurrent detection to be continuous and may prevent damage to components if a short circuit occurred during the startup period.

Although the thresholding function is removed from the microcontroller 402 resulting in an improved overcurrent response time, e.g., less than 100 microseconds, the overcurrent detection circuit 400 shown in FIG. 4A may not be capable of varying the predetermined threshold to trigger a fault condition.

The overcurrent detection circuit 450 of FIG. 4B, however, may provide threshold variation. As shown in FIG. 4B, the first input 406 to the comparator 404 is still fed with the sensing current voltage from the current sense circuit 304. The second input 408 to the comparator is coupled to a low pass filter that may include a resistor 452 and a capacitor 454. The input for the low pass filter may be a pulse output 456 from the microcontroller 402. The frequency or mark space ratio of the pulse waveform is variable by the microcontroller 402. Accordingly, the output of the low pass filter includes a voltage, the amplitude of which is controlled by the frequency or mark space ratio of the pulse waveform generated by the microcontroller 402.

As with the embodiment shown in FIG. 4A, the comparator output is fed to an interrupt input 414 on the microcontroller 402 to obtain the benefit of an improved overcurrent response time.

Although FIGS. 4A and 4B illustrate examples of a hardware-based overcurrent detection circuit for traffic control systems, various changes may be made to FIG. 4A or FIG. 4B. For example, the overcurrent detection circuit may include inrush current limiters to perform one or more of the above functions.

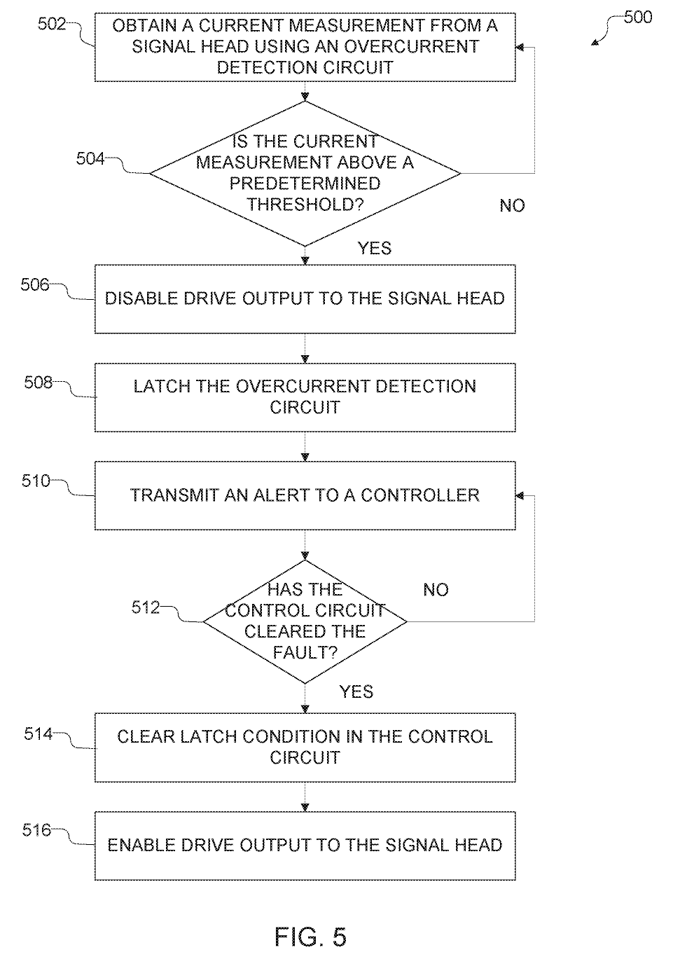

FIG. 5 illustrates a flow chart of an example method 500 for hardware-based short circuit protection of traffic control systems according to various embodiments of the present disclosure. For example, the traffic control cabinet system 200 of FIG. 2 may perform the method 500 using the traffic control power circuit 300 of FIG. 3 and the overcurrent detection circuit 400 of FIG. 4A. An embodiment of the method illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions.

As shown in FIG. 5, the method 500 begins at operation 502 by obtaining a current measurement from a signal head using an overcurrent detection circuit. For example, the current sense circuit 304 may measure or sense a current flow from a signal head.

At operation 504, determine if the current measurement is above a predetermined threshold. For example, the sense current may be sent to the hardware-based overcurrent detection circuit 400 where the sensed current is converted into an analog signal that is processed by the comparator 404 where the sensed current is converted into a sensed voltage and compared to a reference voltage representative of the predetermined threshold. Alternatively, the hardware-based overcurrent detection circuit 450 may be used as described above.

At operation 506, upon determining that the current measurement is above a predetermined threshold, the overcurrent detection circuit is latched. For example, if the sensed current exceeds the predetermined threshold, the comparator 404 latches the switch 418. The comparator 404 also sends an interrupt signal to the microcontroller 402 which, in turn, disables switch 418.

At operation 508, upon determining that the current measurement is above a predetermined threshold, drive output to the signal head is disabled. For example, once the switch 418 is latched, current flow to the driving circuit 312 is ceased, disabling drive output from the driving circuit 312 to the signal head.

At operation 510, upon determining that the current measurement is above a predetermined threshold, an alert is transmitted to the control circuit. For example, once the microcontroller 402 detects the interrupt 414, it may transmit an alert to the controller 202 informing the controller 202 of a fault condition, e.g., current flow exceeded the predetermined threshold, which occurred. The controller 202 may then proceed with necessary corrective action to clear the fault condition.

At operation 512, determine if the control circuit has cleared the fault condition. For example, the microcontroller 402 may standby, e.g. maintain the switch latched, until it receives notification, e.g., via an alert or instruction, that the fault condition was cleared.

Operations 514 and 516 may then occur concurrently. Upon determining that the control circuit has cleared the fault condition, the latch condition will be cleared in the overcurrent detection circuit. For example, the microcontroller 402 will unlatch the switch 418 (operation 514) to allow current flow to the driving circuit 312 which, in turn, will enable drive output to the signal head (operation 516) to resume normal operation.

An advantage of the disclosed method 500 is that, unlike the methods that rely on firmware or software based overcurrent detection, the overcurrent detection circuit is not limited by the processing speed of the microcontroller in sensing and determining if there is excessive current flow in the traffic control system. Instead, the determination of excessive current flow is determined by physical components allowing overcurrent detection in the traffic control system to occur significantly faster than in firmware or software based methods.

Although FIG. 5 illustrates one example method 500 hardware-based short circuit protection of traffic control systems, various changes may be made to FIG. 5. For example, while shown as a series of steps, various steps in FIG. 5 could overlap, occur in parallel, occur in a different order, or occur any number of times.

The present disclosure provides a traffic control cabinet system that allows for much faster overcurrent detection reaction times, e.g., about 10 to about 50 times quicker than current solutions. The traffic control cabinet system of the present disclosure is resettable, allowing for attempted restarts in the event that the failure was caused by transitory events, e.g., signal head startup, as well as rapid recovery of the system once the fault has been resolved.

The above flow charts illustrate example methods that can be implemented in accordance with the principles of the present disclosure and various changes could be made to the methods illustrated in the flow charts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A traffic control cabinet system, comprising:
a controller; and
a traffic control power circuit coupled to the controller, the traffic control power circuit comprising:
a current sensing circuit coupled to a signal head;
a driving circuit configured to supply current flow to the signal head; and
an overcurrent detection circuit, the overcurrent detection circuit comprising:
a conditioning circuit coupled to the current sensing circuit and configured to receive a sensed current from the current sensing circuit;
a comparator coupled to the conditioning circuit;
a microcontroller coupled to the comparator; and
a switch coupled to the driving circuit.

2. The traffic control cabinet system of claim 1, further comprising a first resistor and a second resistor coupled to a second input of the comparator.

3. The traffic control cabinet system of claim 2, wherein the comparator comprises a first input coupled to the conditioning circuit.

4. The traffic control cabinet system of claim 1, wherein the conditioning circuit is configured to apply a time delay to the sensed current received by the conditioning circuit.

5. The traffic control cabinet system of claim 1, wherein the microcontroller is configured to:
upon receiving an interrupt input from the comparator, maintaining the switch in a latched state such that current flow to the signal head is ceased.

6. The traffic control cabinet system of claim 5, wherein the microcontroller is further configured to:
maintaining the switch latched until a signal from the controller is received indicating that a fault condition is cleared.

7. The traffic control cabinet system of claim 6, wherein the microcontroller is further configured to:
upon receiving the signal from the controller indicating that the fault condition is cleared, unlatching the switch and enabling current flow to the signal head.

8. A traffic control power circuit, comprising:
a current sensing circuit coupled to a signal head;
a driving circuit configured to supply current flow to the signal head; and
an overcurrent detection circuit, the overcurrent detection circuit comprising:
a conditioning circuit coupled to the current sensing circuit and configured to receive a sensed current from the current sensing circuit;
a comparator coupled to the conditioning circuit;
a microcontroller coupled to the comparator; and
a switch coupled to the driving circuit.

9. The traffic control power circuit of claim 8, further comprising a first resistor and a second resistor coupled to a second input of the comparator.

10. The traffic control power circuit of claim 9, wherein the comparator comprises a first input coupled to the conditioning circuit.

11. The traffic control power circuit of claim 8, wherein the conditioning circuit is configured to apply a time delay to the sensed current received by the conditioning circuit.

12. The traffic control power circuit of claim 8, wherein the microcontroller is configured to:
upon receiving an interrupt input from the comparator, maintaining the switch in a latched state such that current flow to the signal head is ceased.

13. The traffic control power circuit of claim 12, wherein the microcontroller is further configured to:
maintaining the switch latched until a signal is received indicating that a fault condition is cleared.

14. The traffic control power circuit of claim 13, wherein the microcontroller is further configured to:
upon receiving the signal indicating that the fault condition is cleared, unlatching the switch and enabling current flow to the signal head.

15. A traffic control power circuit, comprising:
a current sensing circuit coupled to a signal head;
a driving circuit configured to supply current flow to the signal head; and
an overcurrent detection circuit, the overcurrent detection circuit comprising:
a conditioning circuit coupled to the current sensing circuit and configured to receive a sensed current from the current sensing circuit;
a comparator coupled to the conditioning circuit by a first input;
a microcontroller coupled to the comparator;
a switch coupled to the driving circuit; and
a first resistor and a second resistor coupled to a second input of the comparator.

16. The traffic control power circuit of claim 15, wherein the conditioning circuit is configured to apply a time delay to the sensed current received by the conditioning circuit.

17. The traffic control power circuit of claim 15, wherein the microcontroller is configured to:
upon receiving an interrupt input from the comparator, maintaining the switch in a latched state such that current flow to the signal head is ceased.

18. The traffic control power circuit of claim 17, wherein the microcontroller is further configured to:
maintaining the switch latched until a signal is received indicating that a fault condition is cleared.

19. The traffic control power circuit of claim 18, wherein the microcontroller is further configured to:
upon receiving the signal indicating that the fault condition is cleared, unlatching the switch and enabling current flow to the signal head.

20. The traffic control power circuit of claim 15, wherein the second input to the comparator is coupled to a low pass filter and an input to the low pass filter may be a pulse output from the microcontroller.
